(19) United States
(12) Patent Application Publication
(10) Pub. No.: US 2004/0056196 A1
(43) Pub. Date: Mar. 25, 2004

(54) Method and apparatus for monitoring environment and apparatus for producing semiconductor

(76) Inventors: Haruo Yoshida, Tokyo (JP); Michio Niwano, Miyagi (JP)

Correspondence Address: Muramatsu & Associates, Suite 225, 7700 Irvine Center Drive, Irvine, CA, 92618, US

(21) Appl. No.: 10/416,236

(22) PCT Filed: Nov. 11, 2001
(86) PCT No.: PCT/JP01/10271

(30) Foreign Application Priority Data
Dec. 1, 2000 (JP) 2000367291

(51) Int. Cl. G01J 1/00; G01T 1/00; G01J 5/02

(52) U.S. Cl. 250/336.1; 250/339.11

(57) ABSTRACT

An environmental monitoring apparatus comprises: an infrared transmitting substrate 12 disposed in a prescribed ambient atmosphere 10; an infrared radiation source 20 for irradiating an infrared radiation to the infrared transmitting substrate 12; a contaminant analyzing means 30 for computing a concentration of a contaminant in the ambient atmosphere 10, based on the infrared radiation exited from the infrared transmitting substrate 12 after the infrared radiation has undergone multiple reflections inside the infrared transmitting substrate 12; and a contaminant removing means 50 for removing the contaminant in the ambient atmosphere 10 complied with the concentration of the contaminant in the ambient atmosphere 10, which have been computed by the contaminant analyzing means 30. Thus, the contaminant in the ambient atmosphere can be monitored with high sensitivity and real time, and can be immediately removed when the concentration in the ambient atmosphere exceed a prescribed value.

### TECHNICAL FIELD

The present invention relates to an environmental monitoring method and apparatus for identifying a contaminant present in a closed space, such as a fabrication apparatus, a clean room or others, or in an exhaust gas or others discharged from the closed space, or measuring a concentration thereof, and controlling an environment in an ambient atmosphere, based on a result of the measurement, and a semiconductor fabrication apparatus comprising the environmental monitoring apparatus.

### BACKGROUND ART

It is very important to control contaminants present in a closed space, as of a semiconductor fabrication apparatus, a clean room, or others.

In a fabrication process of a semiconductor device, for example, while semiconductor wafers are being processed, various processing corresponding to the purposes of the processes is applied to the surfaces of the wafers. In pre-steps of the process, the wafer surfaces are first cleaned by wet cleaning using various chemicals and deionized water, dry cleaning using UV radiation, plasma or others, and then are subjected to surface reforming processing, such as oxidation, etc. The clean wafer surfaces exposed in the cleaning process have so high reactivity with other molecules that during such processing, the wafer surfaces are exposed to an ambient atmosphere contacting the wafers and transiently change, for example, silicon atoms on the surfaces are bonded with hydrogen or oxygen to form oxide films.

In the photolithography apparatus used in the fabrication of semiconductor devices, etc., exposure light is irradiated to a photoresist film applied to the semiconductor wafers to thereby volatile and discharge organic substances contained in the photoresist film into the apparatus. The thus discharged organic substances adhering to the optical lenses and the reflection mirrors, impairing their transmittances and reflectances, and as more wafers are processed, a prescribed exposure cannot be obtained. Resultantly, in a prescribed pattern cannot be made, and the defective products are produced. It is often a case that the organic substances themselves present in the apparatus absorb the exposure light to thereby decrease the exposure light to be irradiated to the semiconductor wafers.

Semiconductor fabrication processes are performed in a clean room and include a number of steps using a number of apparatuses. When the wafers are unloaded from a apparatus to be transferred from one process to another process, the wafers are exposed to the outside atmosphere. At this time, the wafers are oxidized by oxygen in the air and also are often contaminated with certain kinds of contaminants, e.g., organic substances. The wafers are often contaminated with traces of nitrogen oxides, sulfur oxides, etc. It is said that one of contamination sources of organic contamination occurring in clean rooms is organic substances contained in the air in the clean room. It is thought that such organic substances are generated by volatilization of organic substances contained in construction materials of the clean room, air filters, wires, pipes, etc.

Thus, it is very important for higher fabrication yields of semiconductor devices to monitor amounts of contaminants in semiconductor fabrication apparatuses and in the clean room where fabrication processes of the semiconductor devices are performed to thereby identify generation sources of the contaminants and control their generation amounts.

The environmental monitoring is required not only in the clean room used in the fabrication processes for semiconductor devices, but also for contaminants in the air of environments where we live. Recently it has been known that a group of specific substances called environmental endocrine disruptors affects health of the human, and animals and plants. Accordingly, it is also keenly required to monitor exhaust gases from chemical plants, semiconductor plants and cars to control the discharge of such substances.

As conventional methods for monitoring contaminants present in environments, a method for identifying and quantifying contaminants in an environment by adsorbing the contaminants on TENAX, which is a porous material, heating the TENAX to discharge the adsorbed contaminants to identifying and quantifying by mass spectrometer (thermal desorption GC/MS (Gas chromatography/Mass Spectroscopy) method), APMIS (Atmosphere Mass-Ion Spectroscopy) method, TOF-SIMS (Time of Flight-Secondary Ion Mass Spectroscopy) method or others are known.

The above-described conventional measuring methods have good qualitative analysis ability and quantitative analysis ability. However, the methods have disadvantages that their apparatuses are expensive, they take long measuring time (one measurement takes about several hours), their apparatuses have large volumes, and others. Because of these disadvantages, the methods have found it difficult to monitor the presence of contaminants simply and quickly at low cost and feed back measured results to environment control.

### DISCLOSURE OF INVENTION

The present invention relates to an environmental monitoring method and apparatus for identifying a contaminant present in a closed space, such as a fabrication apparatus, a clean room or others, or in the exhaust gas or others discharged from the closed space, or measuring a concentration thereof, and controlling an environment in the ambient atmosphere, based on a result of the measurement, and semiconductor fabrication apparatus comprising the environmental monitoring apparatus, and an object of the present invention is to provide an environmental monitoring method and apparatus which can detect the presence of contaminants simply, quickly and at low cost and feed back a measured result to environment control, and a semiconductor fabrication apparatus including the environmental monitoring apparatus.

The above-described object is attained by an environmental monitoring method comprising the steps of: irradiating an infrared radiation to an infrared transmitting substrate disposed in a prescribed ambient atmosphere; detecting the infrared radiation exited from the infrared transmitting substrate after the infrared radiation has undergone multiple reflections inside the infrared transmitting substrate; measuring a concentration of a contaminant in the ambient atmosphere, based on the detected infrared radiation; and controlling the ambient atmosphere, based on the measured concentration of the contaminant in the ambient atmosphere.

In the above-described environmental monitoring method, it is possible that the detected infrared radiation is spectroscopically analyzed to measure a kind and/or a concentration of the contaminant in the ambient atmosphere.

In the above-described environmental monitoring method, it is possible that the infrared radiation having a wavelength band corresponding to a molecular vibration wavelength of a specific contaminant is selectively detected to measure a concentration of the specific contaminant in the ambient atmosphere.

In the above-described environmental monitoring method, it is possible that the infrared radiation is irradiated to the infrared transmitting substrate while the wavelength of the infrared radiation are being swept, and the concentration of the contaminant in the ambient atmosphere whose molecular vibration wavelength is present in a swept wavelength band are measured.

In the above-described environmental monitoring method, it is possible that when the measured concentration of the contaminant in the ambient atmosphere is higher than a prescribed value, the contaminant in the ambient atmosphere is removed.

The above-described object is also attained by an environmental monitoring apparatus comprising: an infrared transmitting substrate disposed in a prescribed ambient atmosphere; an infrared radiation source for irradiating infrared radiation to the infrared transmitting substrate; a contaminant analyzing means for computing a concentration of a contaminant in the ambient atmosphere, based on the infrared radiation exited from the infrared transmitting substrate after the infrared radiation has undergone multiple reflections inside the infrared transmitting substrate; and a contaminant removing means for removing the contaminant in the ambient atmosphere complied with the concentration of the contaminant in the ambient atmosphere computed by the contaminant analyzing means.

In the above-described environmental monitoring apparatus, it is possible that the contaminant analyzing means measures a kind and/or the concentration of the contaminant in the ambient atmosphere by spectroscopically analyzing the detected infrared radiation.

In the above-described environmental monitoring apparatus, it is possible that the apparatus further comprises: an infrared-band transmitting filter for selectively transmitting the infrared radiation of a wavelength band corresponding to a molecular vibration wavelength of a specific contaminant; and in which the contaminant analyzing means measures the concentration of the specific contaminant in the ambient atmosphere by analyzing the infrared radiation which has passed through the infrared-band transmitting filter.

In the above-described environmental monitoring apparatus, it is possible that the infrared radiation source is a variable emission wavelength-type infrared radiation source which sweeps emission wavelength of the infrared radiation to irradiate the infrared radiation to the infrared transmitting substrate; and the contaminant analyzing means measures the concentration of the contaminant in the ambient atmosphere whose molecular vibration wavelength is present in a wavelength band of the swept infrared radiation, based on the detect infrared radiation.

The above-described object is also attained by a semiconductor fabrication apparatus comprising: semiconductor wafer processing means for performing a prescribed processing on a semiconductor wafer disposed in a prescribed ambient atmosphere; an infrared transmitting substrate disposed in the ambient atmosphere; an infrared radiation source for irradiating an infrared radiation to the infrared transmitting substrate; a contaminant analyzing means for computing a concentration of a contaminant in the ambient atmosphere, based on the infrared radiation exited from the infrared transmitting substrate after the infrared radiation has undergone multiple reflections inside the infrared transmitting substrate; and a contaminant removing means for removing the contaminant in the ambient atmosphere, based on the concentration of the contaminant in the ambient atmosphere computed by the contaminant analyzing means.

In the above-described semiconductor fabrication apparatus, it is possible that the contaminant is a substance which becomes a barrier to proceeding the prescribed processing by the semiconductor wafer processing means.

In the above-described semiconductor fabrication apparatus, it is possible that the semiconductor wafer processing means is an aligner for exposing the semiconductor wafer via optical parts which reflect or transmit light; and the contaminant removing means removes the contaminant adhering to the surfaces of the optical parts.

According to the present invention, Fourier transform infrared spectroscopy using multiple internal reflections is used to identify contaminants in an ambient atmosphere and measure their concentrations, and a result of the measurement is fed back to control of the contaminants, whereby the contaminants in the ambient atmosphere are measured with high sensitivity and real time, and the contaminants can be quickly removed when the contaminants in the atmosphere exceed set values.

### BRIEF DESCRIPTION OF DRAWINGS

FIG. 1 is a diagrammatic view of the environmental monitoring apparatus according to a first embodiment of the present invention, which shows a structure thereof.

FIG. 2 is a graph showing relationships between bonding energies and vibration wavelengths of molecular bonds.

FIG. 3 is a graph showing relationships between concentrations of contaminants in the atmospheric air and densities of the contaminants adhered to the surface of silicon left for 24 hours.

FIG. 4 is a diagrammatic view of the environmental monitoring apparatus according to a second embodiment of the present invention, which shows a structure thereof.

FIG. 5 is graphs of infrared transmission spectra of infrared-band transmitting filters.

FIG. 6 is a diagrammatic view of a modification of the infrared-band transmitting filter of the environmental monitoring apparatus according to the second embodiment of the present invention.

FIG. 7 is a diagrammatic view of the environmental monitoring apparatus according to a third embodiment of the present invention, which shows a structure thereof.

FIG. 8 is diagrammatic view of a modification of an infrared radiation source of the environmental monitoring apparatus according to the third embodiment of the present invention.

FIG. 9 is a diagrammatic view of the semiconductor fabrication apparatus according to a fourth embodiment of the present invention, which shows a structure thereof.

FIG. 10 is a diagrammatic view of the semiconductor fabrication apparatus according to a fifth embodiment of the present invention, which shows a structure thereof.

### BEST MODES FOR CARRYING OUT THE INVENTION

[A First Embodiment]

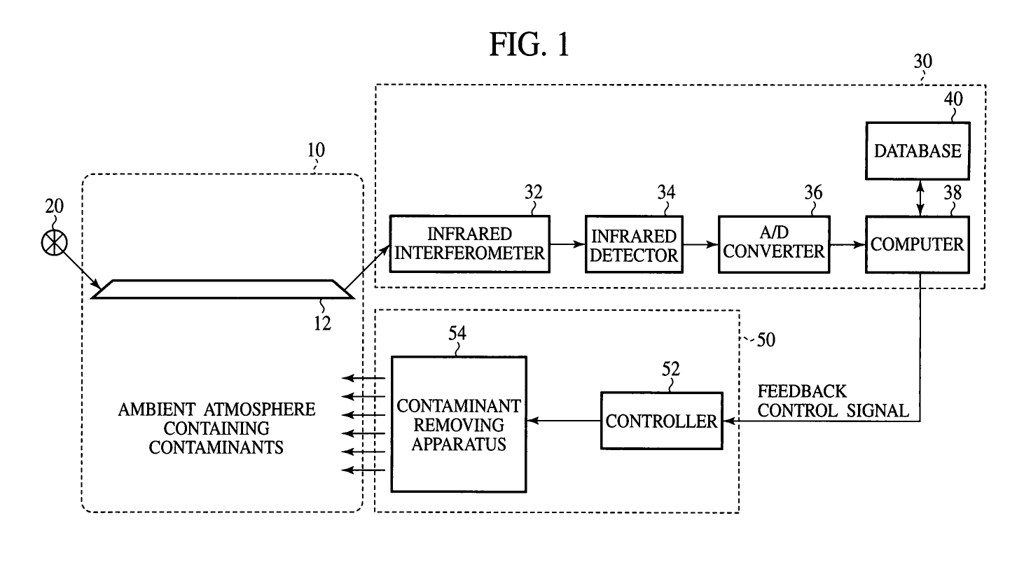

The environmental monitoring method and apparatus according to a first embodiment of the present invention will be explained with reference to FIGS. 1 to 3.

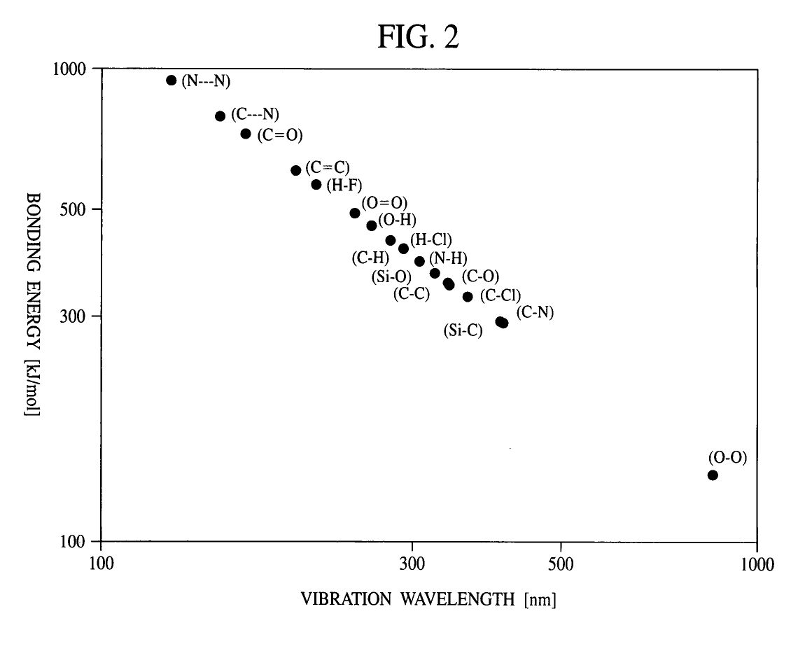

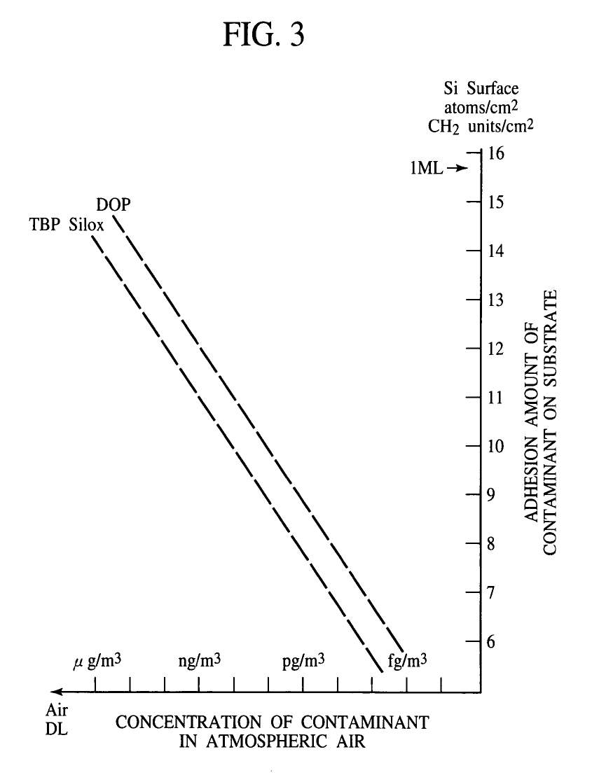

FIG. 1 is a diagrammatic view of the environmental monitoring apparatus according to the present embodiment, which shows a structure thereof. FIG. 2 is a graph of relationships between bond energies of molecular bonds and oscillation wavelengths. FIG. 3 is a graph of relationships between concentrations of contaminants in the atmospheric air and densities of the contaminants adhered to the surface of silicon left for 24 hours.

FIG. 1 is a diagrammatic view of the environmental monitoring apparatus according to the present embodiment, which shows a structure thereof. FIG. 2 is a graph showing relationships between bonding energies and vibration wavelengths of molecular bonds. FIG. 3 is a graph showing relationships between concentrations of contaminants in the atmospheric air and densities of the contaminants adhered to the surface of silicon left for 24 hours.

[1] General Constitution of the Environmental Monitoring Apparatus

The structure of the environmental monitoring apparatus according to the present embodiment will be explained with reference to FIG. 1.

In an ambient atmosphere 10 containing contaminants, an infrared transmitting substrate 12 which adsorbs the contaminants in the ambient atmosphere 10 for the measurement is disposed. An infrared radiation source 20 which irradiates infrared radiation to the infrared transmitting substrate 12 to cause the infrared radiation to make multiple internal reflections in the substrate 12 is disposed on the side of one end surface of the infrared transmitting substrate 12. A contaminant analyzing means 30 which detects the infrared radiation which has made the multiple internal reflections and exited from the infrared transmitting substrate 12 and analyzes the contaminants in the ambient atmosphere 10, based on the detected infrared radiation is disposed on the side of the other end surface of the infrared transmitting substrate 12. The contaminant analyzing means 30 includes contaminant removing means 50 which removes the contaminants in the ambient atmosphere 10, based on analysis results of the contaminant analyzing means 30.

Thus, the environmental monitoring apparatus according to the present embodiment is characterized mainly in that the apparatus comprises the contaminant analyzing means which detects contaminants in the ambient atmosphere by multiple internal reflection Fourier transform infrared spectroscopy (FTIR-MIR), and the contaminant removing means which controls an environment in the ambient atmosphere, based on detected results provided by the contaminant analyzing means.

The multiple internal reflection Fourier transform infrared spectroscopy is a method in which infrared radiation is incident on the infrared transmitting substrate having both surfaces polished, and the infrared radiation which has made multiple reflections in the infrared transmitting substrate and exited is measured to detect contaminants adhering to the surfaces of the substrate. When infrared radiation is incident on one end of the substrate at a specific incidence angle, the infrared radiation propagates, repeating total reflections on both surfaces inside the substrate. In the propagation, evanescent light oozes out on the substrate surfaces, and parts of infrared spectra are absorbed by organic substances adhered to the surfaces. The propagating radiation exited from the other end of the substrate is spectroscopically analyzed by FT-IR, whereby the organic substances adhering to the substrate surfaces can be detected and identified. When the substrate is left in the environment, contaminants contained in the ambient atmosphere of the environment adhere to the substrate. The organic substances adhering to the surfaces are measured, whereby contaminants present in the environmental atmosphere can be indirectly measured.

The environmental monitoring apparatus is thus arranged, whereby contaminants in the ambient atmosphere can be monitored real time, and monitored results can be immediately fed back to the environment control.

The respective constituent members of the environmental monitoring apparatus according to the present embodiment will be detailed below.

(a) Infrared Transmitting Substrate 12

As described above, the infrared transmitting substrate 12 is used to adsorb and measure contaminants, objects to be measured, in the ambient atmosphere 10, and must be a material transmitting light of a wavelength band corresponding to molecular vibrations of the object to be measured. A wavelength band which corresponds to fundamental vibrations of organic substances, which are typical contaminants, is an infrared/near infrared band of about 500 cm⁻¹ (20 μm wavelength)−5000 cm⁻¹ (2 μm wavelength). Accordingly, a material of the infrared transmitting substrate 12 is selected out of a group of infrared transmitting substances which can transmit radiation of such wave number band (wavelength band).

Material transmitting the radiation of the infrared/near infrared band are exemplified by silicon (Si, transmitting band of wavelength: 1.2-6 μm), potassium bromide (KBr, transmitting band of wavelength: 0.4-22 μm), potassium chloride (KCl, transmitting band of wavelength: 0.3-15 μm), zinc selenide (ZnSe, transmitting band of wavelength: 0.6-13 μm), barium fluoride (BaF₂, transmitting band of wavelength: 0.2-5 μm), cesium bromide (CsBr, transmitting band of wavelength: 0.5-30 μm), germanium (Ge, transmitting band of wavelength: 2-18 μm), lithium fluoride (LiF, transmitting band of wavelength 0.2-5 μm), calcium fluoride (CaF₂, transmitting band of wavelength: 0.2-8 μm), sapphire (Al₂O₃, transmitting band of wavelength: 0.3-5 μm), cesium iodide (CsI, transmitting band of wavelength: 0.5-28 μm), magnesium fluoride (MgF₂, transmitting band of wavelength: 0.2-6 μm), thallium bromide (KRS-5, transmitting band of wavelength: 0.6-28 μm), zinc sulfide (SnS, transmitting band of wavelength: 0.7-11 μm), etc. Thus, the infrared transmitting substrate 12 can be formed of these materials. Some of these materials have deliquescent and are unsuitably depending on environments where they are used. It is preferable that a material forming the infrared transmitting substrate 12 is selected suitably corresponding to the environment where it is to be used and a required transmitting band of wavelength.

The infrared transmitting substrate 12 can have the configuration in the strip shape having the side surfaces tapered by 45° as exemplified in FIG. 1. The infrared transmitting substrate 12 can be in the form of, e.g., the substrate having a plurality of infrared radiation propagation lengths as described in the specification of Japanese Patent Application No. Hei 11-231495. A 300 mm-silicon wafer, for example, may be used as described in the specification of Japanese Patent Application No. Hei 11-95853. The use of a silicon wafer as it is has a merit that the wafer can be cleaned (initialized) by a conventional semiconductor fabrication apparatus.

The environmental monitoring apparatus identifies and quantifies contaminants adsorbed on the surfaces of the infrared transmitting substrate 12 to measure the contaminants in an environmental atmosphere. Amounts of contaminants adsorbed on the infrared transmitting substrate 12 are saturated as time passes. Accordingly, when changes of concentrations of contaminants in the atmospheric air must be monitored over a long period of time, a cleaning step of periodically removing the contaminants adsorbed on the surfaces of the infrared transmitting substrate 12 is necessary.

As the step of initializing the infrared transmitting substrate 12, for example, an UV radiation source is disposed near the infrared transmitting substrate 12, and means for removing the contaminants by irradiating UV radiation from the UV radiation source may be used. UV radiation, whose energy is higher than bonding energies of the adhering organic contaminants, can dissociate and evaporate the organic contaminants adhering to the infrared transmitting substrate 12. The UV radiation source for removing the contaminants can be, for example, a Xe (xenon) excimer light, a low pressure mercury lamp having 185 nm- and 254 nm-emission wavelengths, a dielectric barrier discharge excimer lamp having a 172 nm-emission wavelength or others. The irradiation of the light having such energies dissociates bonds, such as C—C, C—H, C—O, etc., of the organic contaminants and remove or evaporate from the surfaces of the infrared transmitting substrate 12.

To remove the contaminants, other chemical or physical removing means may be used. In the environmental monitoring apparatus according to the present embodiment, reflections and absorptions take place both on the upper surface and the lower surface of the infrared transmitting substrate 12, and both surfaces of the substrate must be cleaned. Reflection mirrors may be provided so as to efficiently irradiate the UV radiation emitted from the UV radiation source efficiently to both sides of the infrared transmitting substrate 12 as described in Japanese Patent Application No. Hei 11-231495.

(b) Infrared Radiation Source 20

As the infrared radiation source, a radiation source which emits infrared radiation of a 2-25 μm-band corresponding to molecular vibrations of organic molecules can be used.

For example, heat rays emitted from filaments of silicon carbide (SiC) or nichrome wire upon application of current thereto can be used the infrared radiation source 20. The infrared radiation source using SiC, such as an SiC Globar lamp or others, emits infrared radiation of a 1.1-25 μm-band and is characterized by no damage even in bare use in the air.

A semiconductor laser or a light emitting diode, whose emission wavelengths are in the infrared/near infrared band, can be used as the infrared radiation source. The infrared radiation source comprising a semiconductor laser or a light emitting diode is characterized in that the infrared radiation source is small-sized and can easily form small focuses on the end surfaces of the substrate.

For higher efficiency of the light source and higher intensities of the infrared radiation, reflection plates may be provided. Other various infrared radiation sources described in, e.g., the specification of Japanese Patent Application No. Hei 11-95853 can be used as the infrared radiation source 20.

(c) Contaminant Analyzing Means 30

The contaminant analyzing means 30 is, e.g., a spectrometer of an FT-IR apparatus, which is based on a double beam interferometer (Michelson interferometer) and spectroscopically forming spectra of the infrared radiation by the mechanism of Fourier transform spectroscopy. The contaminant analyzing means 30 comprises an infrared interferometer 32 which generates interferogram (interference wave profiles) of the detected infrared radiation, an infrared detector 34 which converts the infrared interferogram generated by the infrared interferometer 32 to electric signal, an A/D converter 36, a computer 38 which Fourier-transforms the interferogram converted to the electric signal to the wavelength (frequency) region, and a database 40 which is referred to for identification, quantification, etc. of the contaminants.

The infrared radiation which has exited from the infrared transmitting substrate 12 is incident on the infrared interferometer 32 and converted to the electric signal by the infrared detector 34, and the interferogram converted to the electric signal is Fourier-transformed to the wavelength (frequency) region by the computer 38, whereby resonance absorption spectra in the wavelength region can be obtained.

FIG. 2 is a graph of relationships between bonding energies and vibration wavelengths of molecular bonds. As shown, the vibration wavelengths of the molecules are in the infrared region, and the respective molecular functional groups (groups of bonded atoms) exhibit absorption spectra in the respective vibration wavelength bands. Accordingly, the resonance absorption spectra of the infrared radiation are analyzed, so that the contaminants adhering to the substrate can be identified. Databases of infrared absorption spectra for the substance identification are fully prepared and are commercially available.

A ratio (−log(I₁/I₀)) of a resonance absorption spectral intensity I₀ obtained on the substrate without any contaminant to a resonance absorption spectral intensity I₁ obtained on the substrate with contaminants adhering to, which is expressed in logarithm and sign-inverted is defined as an absorbance, and based on an intensity of the absorbance, amounts of the contaminants on the substrate can be computed.

Kinds of organic contaminants and calibration curves are stored in the independent database 40, and measured data are quantified with reference to the data. The database 40 also stores relationships between amounts of contaminants adsorbed on the surface of the infrared transmitting substrate 12 and amounts of the contaminants in the air, and based on amounts of detected contaminants on the infrared transmitting substrate 12, concentrations of the contaminants in the air can be computed. The method for quantifying concentrations of contaminants in the ambient atmosphere will be described later.

It is possible that a display (not shown) is provided, connected to the computer 38 to display an analyzed result given by the computer 38.

A measuring time of multiple internal reflections Fourier transform infrared spectroscopy is as short as about 1/100 of that of the conventional analyzing method, because the infrared radiation to be used in the measurement instantaneously passes through the infrared transmitting substrate 12, making multiple reflections. The short-time measurement makes it possible to grasp dynamic state changes. The contaminant analyzing means 30 is suitable as a sensor for the feedback operation for realizing the purpose of maintaining a prescribed state. The conventional measuring method requires vacuum fields or strong magnetic fields for the analysis, while the present invention requires no special field and can perform the analysis in the air. Accordingly, characteristically, this can make the apparatus small-sized and make the maintenance cost low.

(d) Contaminant Removing Means 50

The contaminant removing means 50 controls the contaminant removing apparatus 54, based on the feedback control signal from the contaminant analyzing means 30, to remove contaminants in an environment. As exemplified in FIG. 1, the contaminant removing means 50 comprises the contaminant removing apparatus 54 and the controller 52 for controlling the contaminant removing apparatus 54.

The computer 38 outputs the feedback control signal when the contaminant detected by the contaminant analyzing means 30 has a larger value than a prescribed value, and controls the controller 52, whereby the contaminant removing apparatus 54 is driven through the controller 52 to remove the contaminant in the environment.

The contaminant removing means 54 can be provided by the same UV radiation source as used in initializing the infrared transmitting substrate 12. A plasma generator may be provided in place of the UV radiation source to decompose contaminants by plasmas. It is also possible to use exhaust means for exhausting contaminants from the environment.

The contaminant removing apparatus 54 may be used commonly in initializing the infrared transmitting substrate 12.

[2] Quantification of Contaminant Concentration in Ambient Atmosphere

In the environmental monitoring method according to the present invention, amounts of contaminants adhering to the infrared transmitting substrate 12 or present near the infrared transmitting substrate 12 are measured by multiple internal reflections infrared spectroscopy and are converted to contaminant concentrations in the ambient atmosphere. That is, contaminant concentrations in the ambient atmosphere are not directly measured. Accordingly, in order to measure concentrations of contaminants in the ambient atmosphere based on amounts of the contaminants present near the infrared transmitting substrate 12, it is necessary that relationships between contaminant concentrations in the ambient atmosphere and the absorbances at infrared absorption peaks are given in advance so as to prepare calibration curves. It is not essential to compute absolute values of amounts of adhesion to the infrared transmitting substrate 12.

In preparing calibration curves expressing contaminant concentrations in the ambient atmosphere and absorbances of absorption peaks, first their relationships will be discussed.

As a concentration of a contaminant in the ambient atmosphere is higher, the contaminant is more apt to adhere to the infrared transmitting substrate 12. Accordingly, increase of the concentration of the contaminant in the ambient atmosphere causes the contaminant to more adhering to the infrared transmitting substrate 12. Here, when a contaminant concentration in the ambient atmosphere is represented by C, a conversion coefficient between an adhesion amount and a concentration is represented by K₁, and an adhesion amount of the contaminant to the infrared transmitting substrate 12 is represented by W, the following relationship hold among them.

C=K₁×W (1)

On the other hand, a transmitted radiation amount I after the infrared transmitting substrate 12 has been contaminated can be expressed by the following formula:

I=Iₒ×exp(−W×N×α) (2)

where a transmitted radiation mount before contaminated is represented by I₀, an internal reflection number is represented by N, and an absorbance coefficient per a unit adhesion amount for one reflection is represented by α.

An absorbance A is expressed by

A=−log₁₀(I/I₀) (3)

Accordingly, by using formula (2) and Formula (3), the absorbance A can be rewritten as follows:

A∝W×N×α (4)

Accordingly, when a conversion coefficient between the absorbance and the concentration is K₂, Formula (1) can be rewritten as follows:

C=K₂×A (5)

Based on Formula (1) and Formula (5), it is seen that proportional relationships hold between the contaminant concentration and the amount of adhesion to the substrate, and between the contaminant concentration and absorbance. Accordingly, the amount of the contaminant adhering to the infrared transmitting substrate 12 exposed to the ambient atmosphere is given based on the absorbance and is multiplied by the conversion coefficient to compute the concentration of the contamination in the ambient atmosphere.

The conversion coefficient can be measured by, e.g., the following procedures.

1) First, expose the infrared transmitting substrate 12 in a space where a contaminant is present in a certain concentration.

2) Next, measure a concentration of the contaminant in a gas by another means (a gas detecting tube, gas chromatography or others).

3) Next, measure an absorbance of an absorption peak by the contaminant adhering to the infrared transmitting substrate 12.

4) Then, repeat the above-described procedures 1) to 3) and give a conversion coefficient, based on a ratio of results of the procedures 2) and 3).

It is preferable that an exposing time of the substrate is constant. When the exposing time varies, the adhesion amount of the contaminant often varies for the same concentration, and in such case, the absorbance must be converted so as to make the exposing time constant. To this end, it is necessary that absorbances are given at a suitable interval while the infrared transmitting substrate 12 is being exposed in the ambient atmosphere, to give a relationship between the exposing time and absorbance in advance.

For the accurate measurement, internal reflection conditions must be the same, and the infrared radiation must be incident on the same substrate or the substrate of the same configuration under the same conditions. Contaminants of different kinds have different absorbances, and for the accurate quantitative measurement, conversion coefficients of all the substances to be measured must be measured in advance.

When the adhesion amount per a unit area on the substrate is computed, a calibration curve is prepared in advance by the following procedures.

1) First, prepare a plurality of solutions of different concentrations of a contaminant diluted with a volatile solvent.

2) Next, apply prescribed amount of the solution to the substrate.

3) Then, let the substrate with the solution applied to stand for a suitable period of time to evaporate the solvent.

4) Then, measure absorbance of absorption peak by the contaminant adhering to the substrate by the multiple internal reflection method.

5) Next, compute the adhesion amount of the contaminant per a unit area, based the concentration of the solution, application amount of the solution and the substrate area.

6) Then, prepare calibration curve, based on the adhesion amounts and the absorbances.

Thus, the absorbance obtained by exposing the substrate to the ambient atmosphere is compared with the calibration curve to thereby give absolute amount of the contaminant adhering to the substrate.

FIG. 3 is a graph of relationships between concentrations of chemical contaminants in the air and contamination of the surface of a silicon wafer as the infrared transmitting substrate which has been left in the air for 24 hours. It shows that in the case of DOP (dioctyl phthalate), when the wafer is left in the air of, e.g., a 1 ng/m³ DOP concentration for 24 hours, an adhesion amount of DOP to the wafer surface is 10¹² CH₂ unit/cm². Oppositely, when an adhesion amount to the wafer surface is 10¹² CH₂ unit/cm², it is found that the DOP concentration in the air is 1 ng/m³. On the other hand, as seen in the cases of TBP (tributyl phosphate: flame retardant) and siloxane (a volatile substance from silicone caulking agents), the relationship between the concentration in the air and the adhesion amount varies depending on conditions, as of contaminants, standing time, etc. Accordingly, it is necessary to give in advance relationships between concentrations in the air and adhesion amounts for respective substances to be measured. Calibration curves as shown in FIG. 3 are prepared in advance and stored in the database 40, whereby concentrations of contaminants present in the ambient atmosphere can be computed based on amounts of the contaminants adhering to the infrared transmitting substrate 12. It is also possible that in place of the calibration curves shown in FIG. 3, calibration curves showing relationships between concentrations of the contaminants in the ambient atmosphere and absorbances at absorption peaks are prepared in advance and stored in the database 40, whereby concentrations of the contaminants present in the atmosphere are computed.

[3] Environmental Monitoring Method

The environmental monitoring method according to the present embodiment will be explained with reference to FIG. 1.

First, the infrared transmitting substrate 12 is disposed in the ambient atmosphere 10 to be measured. In FIG. 1, the infrared transmitting substrate 12 alone is disposed in the ambient atmosphere 10, but all or a part of the infrared radiation source 20, the contaminant analyzing means 30 and the contaminant removing means 50 may be disposed in the ambient atmosphere 10.

Next, the infrared radiation emitted from the infrared radiation source 20 is irradiated to the infrared transmitting substrate 12. The infrared radiation entering the infrared transmitting substrate 12 undergoes multiple internal reflections on the front and the back surfaces of the infrared transmitting substrate 12, while probing contaminants adhering to the surfaces of the infrared transmitting substrate 12, collecting information of the contaminants, and exits from the infrared transmitting substrate 12 to the outside.

Next, the infrared radiation which has exited from the infrared transmitting substrate 12 is detected by the infrared radiation detector 34 via the infrared interferometer 32, and the contaminants are identified and quantified by the computer 38.

Then, when the concentration of the contaminant in the ambient atmosphere 10, which has been computed by the computer 38 is larger than a prescribed value, the computer 38 outputs feedback control signals to the controller 52. The controller 52 which has received the feedback control signals drives the contaminant removing apparatus 54 to decompose/discharge the contaminant in the ambient atmosphere 10. Thus, a concentration of the contaminant in the ambient atmosphere 10 is kept lower than the prescribed value.

Then, UV radiation emitted from the UV radiation source not shown is irradiated as required to the infrared transmitting substrate 12 to thereby remove contaminants adsorbed on the surfaces of the infrared transmitting substrate 12 to initialize the substrate surfaces.

Next, the above-described measurement is repeated as required to thereby measure transient changes, etc. of contaminants in the ambient atmosphere.

As described above, according to the present embodiment, contaminants in an ambient atmosphere are identified, and concentrations of the contaminants are measured by Fourier transform infrared spectroscopy using multiple internal reflections of infrared radiation in the infrared transmitting substrate 12, and measured results are fed back to control the contaminants in the ambient atmosphere 10, whereby the contaminants in the ambient atmosphere are measured with high sensitivity and real time, and the contaminants in the ambient atmosphere can be immediately removed when they exceed prescribed values.

[A Second Embodiment]

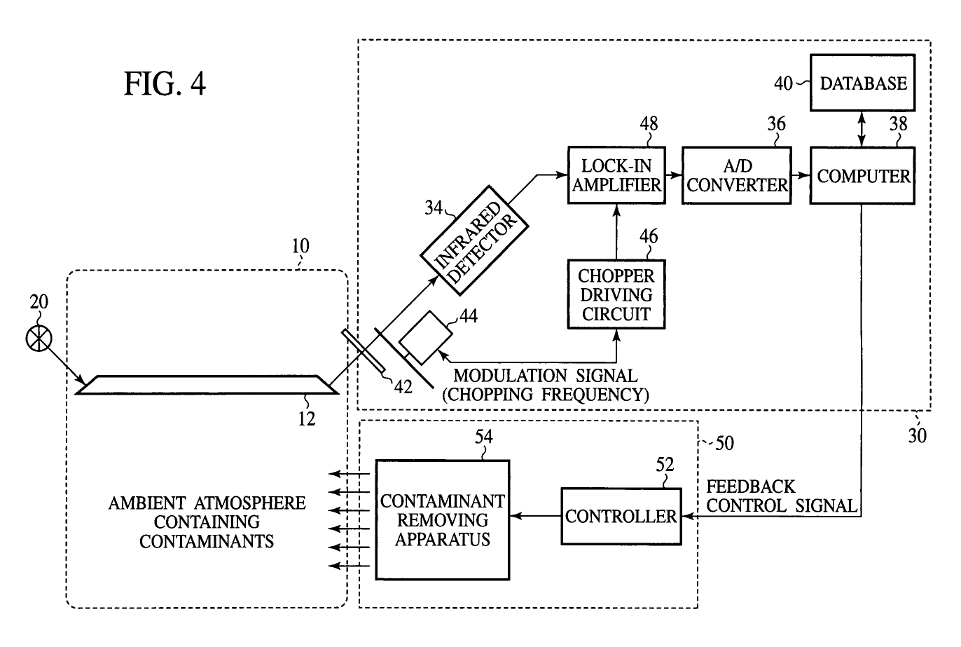

The environmental monitoring method and apparatus according to a second embodiment of the present invention will be explained with reference to FIGS. 4 to 6. The same members of the present embodiment as those of the environmental monitoring method and apparatus according to the first embodiment shown in FIGS. 1 to 3 are represented by the same reference numbers not to repeat or to simplify their explanation.

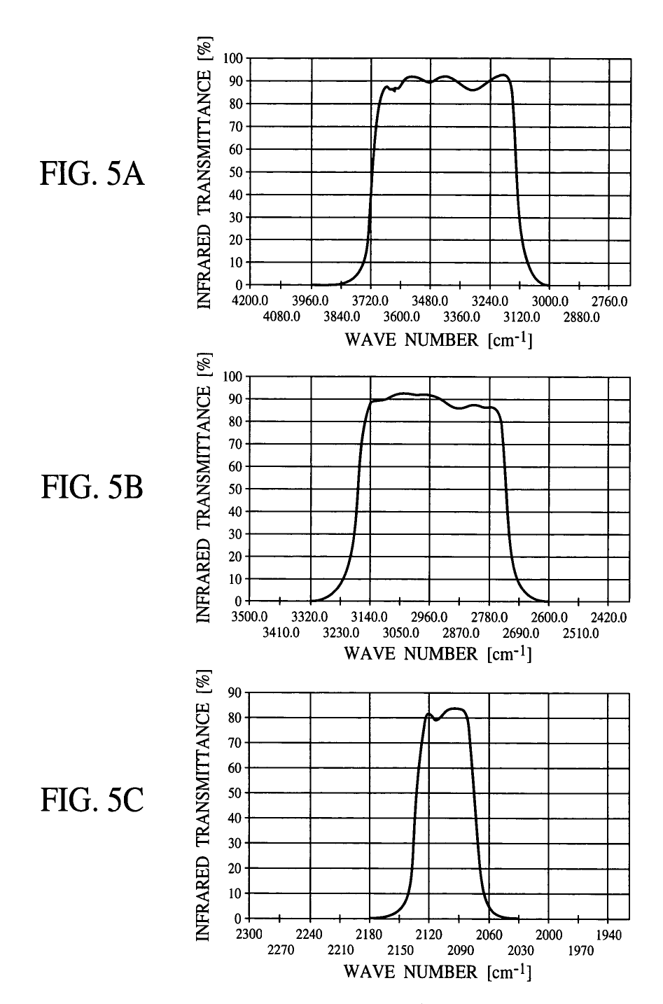

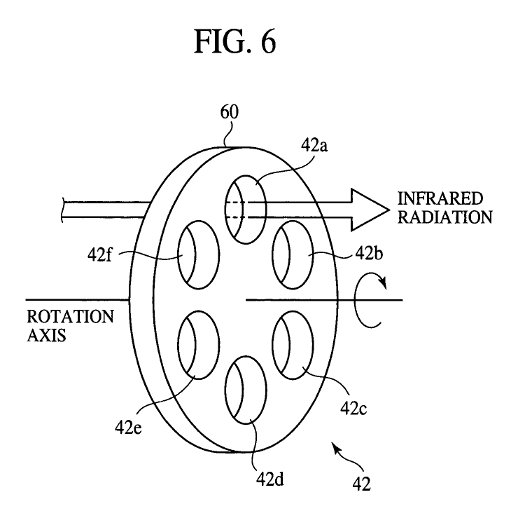

FIG. 4 is a diagrammatic view of the environmental monitoring apparatus according to the present embodiment, which shows the structure thereof. FIG. 5 is graphs of infrared transmission spectra of infrared-band transmitting filters. FIG. 6 is a diagrammatic view of a modification of the infrared-band transmitting filter of the environmental monitoring apparatus according to the present embodiment.

In the environmental monitoring apparatus according to the first embodiment, the infrared radiation source having emission wavelength band including molecular vibration wavelengths of various contaminants is used to identify and quantify contaminants by multiple internal reflections Fourier transform infrared spectroscopy. However, for some of ambient atmospheres which require the control of contaminants contained, contaminants which influences on the ambient atmosphere are known. In such case, only absorbances of infrared radiation in wavelength bands corresponding to molecular vibrations of functional groups (e.g., C—H group, O—H group, Si—H group, etc.) which are specific to the contaminants are measured, which is sufficient to analyze the contaminants.

Then, in the environmental monitoring apparatus according to the present embodiment, an infrared-band transmitting filter 42 is disposed between the infrared transmitting substrate 12 and the infrared radiation detector 34 to selectively detect only infrared radiation of a specific wavelength band. Concentrations of specific contaminants corresponding to the wavelength band are computed, and based on computed concentrations, feedback is made to control the contaminants in the ambient atmosphere 10.

That is, the environmental monitoring apparatus according to the present embodiment is the same as that according to the first embodiment in that, as shown in FIG. 4, the former includes the contaminant analyzing means 30 which detects infrared radiation exited from the infrared transmitting substrate 12 placed in the ambient atmosphere (closed space) 10 after multiple internal reflections therein to thereby analyze contaminants present in the ambient atmosphere 10, and the contaminant removing means 50 which removes the contaminants in the ambient atmosphere, based on results of the analysis. A main characteristic of the environmental monitoring apparatus according to the present embodiment is that in place of the infrared interferometer 32 disposed between the infrared transmitting substrate 12 and the infrared detector 34, an infrared-band transmitting filter 42 to thereby selectively lead only infrared radiation of a specific wavelength band to the infrared detector 34.

The environmental monitoring apparatus having such structure does not require the infrared interferometer 32 (FT-IR apparatus), which is expensive, and the apparatus can be accordingly inexpensive.

The infrared-band transmitting filters for molecular vibration wavelengths of specific functional groups are marketed by, e.g., SPECTROGON US Inc. FIG. 5 shows graphs of examples of infrared transmitting spectra given by the infrared-band transmitting filters marketed by the company. FIG. 5A, FIG. 5B and FIG. 5C are respectively for a filter which transmits a wavelength band corresponding to the molecular vibration of O—H group, for a filter which transmits a wavelength band corresponding to the molecular vibration of C—H group, and for a filter which transmits a wavelength band corresponding to molecular vibration of Si—H group. The infrared-band transmitting filter 42 of the environmental monitoring apparatus according to the present embodiment can be provided by such filters.

In the environmental monitoring apparatus according to the present embodiment, a chopper 44 is disposed between the infrared-band transmitting filter 42 and the infrared detector 34 and is driven by a chopper driving circuit 46, and a lock-in amplifier 48 is disposed between the infrared detector 34 and the A/D converter 36. A chopping frequency of the chopper 44 and the detection of the infrared radiation are synchronized for higher S/N ratios. The chopper 44, the chopper driving circuit 46 and the lock-in amplifier 48 are not essential. The chopper 44 may be disposed between the infrared radiation source 20 and the infrared transmitting substrate 12.

Next, the environmental monitoring method according to the present embodiment will be explained with reference to FIG. 4.

First, the infrared transmitting substrate 12 is disposed in the ambient atmosphere 10 to be measured. In FIG. 4, the infrared transmitting substrate 12 alone is disposed in the ambient atmosphere 10, but all or a part of the infrared radiation source 20, the contaminant analyzing means 30 and the contaminant removing means 50 may be disposed in the ambient atmosphere 10.

Next, the infrared radiation emitted from the infrared radiation source 20 is irradiated to the infrared transmitting substrate 12. The infrared radiation entering the infrared transmitting substrate 12 undergoes multiple internal reflections on the front and the back surfaces of the infrared transmitting substrate 12, while probing contaminants adhering to the surfaces of the infrared transmitting substrate 12, collecting information of the contaminants, and exits from the infrared transmitting substrate 12 to the outside.

Then, the infrared radiation exited from the infrared transmitting substrate 12 is detected by the infrared detector 34 through the infrared-band transmitting filter 42. Thus, the infrared detector 34 detects only the infrared radiation of a wavelength corresponding to a molecular vibration wavelength of a specific contaminant.

Next, based on the infrared intensity detected by the infrared detector 34, the computer 38 computes the absorbance spectrum of the infrared radiation to identify and quantify the contaminant.

Then, when the concentration of the contaminant in the ambient atmosphere 10, which has been computed by the computer 38, is higher than a prescribed value, the computer 38 outputs feedback control signal to the controller 52. The controller 52 which has received the feedback control signal drives the contaminant removing apparatus 54 to decompose/discharge the contaminant in the ambient atmosphere 10. Thus, the contaminant concentration in the ambient atmosphere can be kept lower than the prescribed value.

Next, UV radiation emitted from the UV radiation source not shown is irradiated as required to the infrared transmitting substrate 12 to thereby remove the contaminants adsorbed on the surfaces of the infrared transmitting substrate 12 to initialize the substrate surfaces.

Next, the above-described measurement is repeated as required to thereby measure transient changes, etc. of the contaminant in the ambient atmosphere.

As described above, according to the present embodiment, the infrared-band transmitting filter is disposed to detect only the infrared radiation of a wavelength band corresponding to the molecular vibration wavelength of the specific contaminant to measure the concentration of the specific contaminant, and based on the concentration, feedback is made to the control of the contaminant in the ambient atmosphere 10. Accordingly, no FT-IR apparatus, which is expensive, is necessary, which makes the apparatus inexpensive.

In the present embodiment, the infrared-band transmitting filter 42 is disposed between the infrared transmitting substrate 12 and the infrared detector 34. However, a plurality of the infrared transmitting filters having different transmitting bands is prepared, and the infrared radiation which has passed through these filters are sequentially analyzed so as to analyze plural specific contaminants.

As exemplified in FIG. 6, the infrared-band transmitting filter 42 having a plurality of infrared-band transmitting filters 42a-42f whose transmitting bands are different from one another arranged on a rotary disc 60 along a conical circumference is prepared. The infrared-band transmitting filter 42 is rotated on the rotation axis to thereby sequentially shift the infrared-band transmitting filters 42a-42f for the infrared radiation exited from the infrared transmitting substrate 12 to be transmitted. The rotation of the rotary disc 60 for the selection of the infrared-band transmitting filters 42a-42f is controlled, for example, in response to filter setting signals given by the computer 38.

In the present embodiment, the infrared-band transmitting filter 42 is disposed between the infrared transmitting substrate 12 and the infrared detector 34 but may be disposed between the infrared radiation source 20 and the infrared transmitting substrate 12.

[A Third Embodiment]

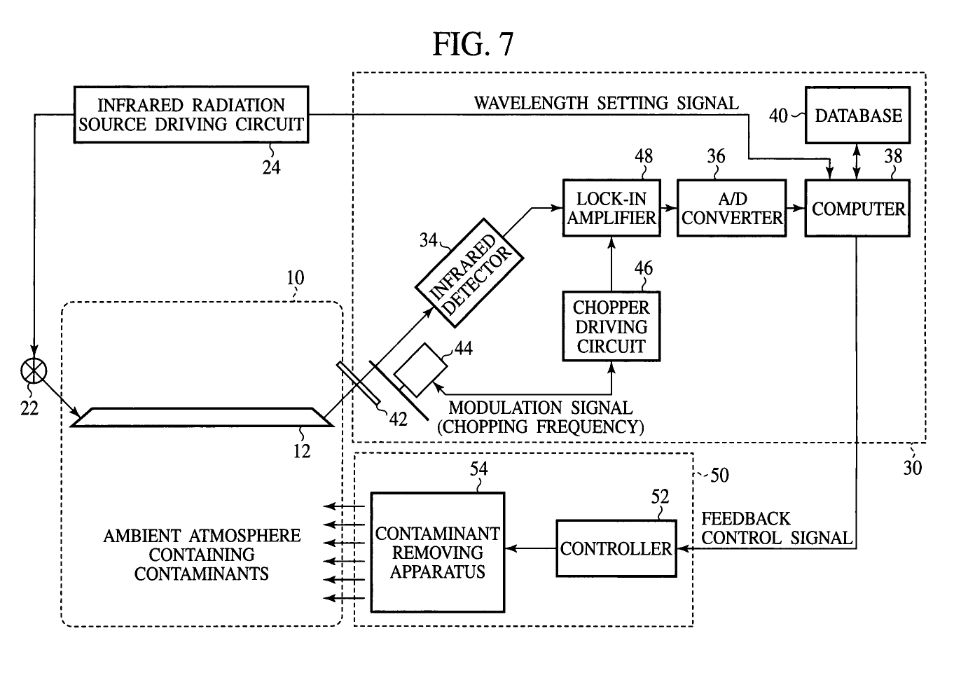

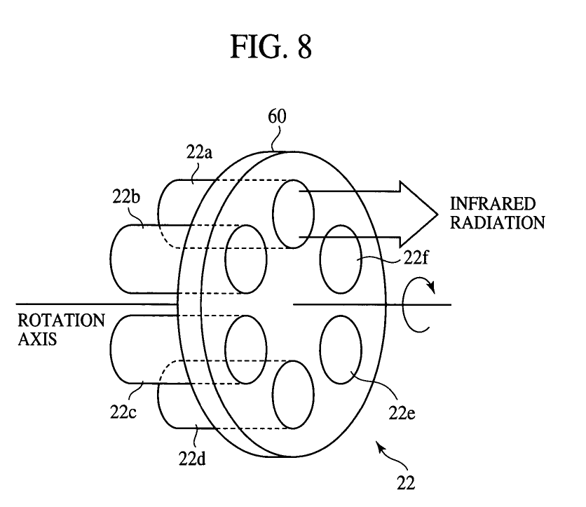

The environmental monitoring method and apparatus according to a third embodiment of the present invention will be explained with reference to FIGS. 7 and 8. The same members of the present embodiment as those of the environmental monitoring method and apparatus according to the first and the second embodiments shown in FIGS. 1 and 6 are represented by the same reference numbers not to repeat or to simplify their explanation.

FIG. 7 is a diagrammatic view of the environmental monitoring apparatus according to the present embodiment, which shows a structure thereof. FIG. 8 is a diagrammatic view of a modification of an infrared radiation source of the environmental monitoring apparatus according to the present embodiment.

In the environmental monitoring apparatus according to the first embodiment, the infrared radiation source has emission wavelength band including molecular vibration wavelength bands of various contaminants, and contaminants are identified and quantified by multiple internal reflections Fourier transform infrared spectroscope. However, as described above, FT-IR apparatus are large-sized and expensive. For smaller sizes and inexpensiveness of the environmental monitoring apparatus, it is preferable to use the other infrared analyzing means in place of the FT-IR apparatus. On the other hand, the environmental monitoring apparatus according to the second embodiment, which analyzes the infrared radiation having specific wavelength band, is not always suitable and unsuitable when contaminants are unknown, or a plurality of contaminants must be detected.

Then, in the environmental monitoring apparatus according to the present embodiment, emission wavelength of the infrared radiation emitted by the infrared radiation source is swept, and synchronously therewith the infrared radiation exited from the infrared transmitting substrate is analyzed to thereby compute concentrations of one, or two or more contaminants of molecular vibration wavelengths included a wavelength sweep range, and based on the computed concentrations, feedback is made to control contaminants in the ambient atmosphere 10.

That is, the environmental monitoring apparatus according to the present embodiment is the same as that according to the first embodiment in that, as shown in FIG. 7, the former includes the contaminant analyzing means 30 which detects infrared radiation exited from the infrared transmitting substrate 12 placed in the ambient atmosphere (closed space) 10 after multiple internal reflections therein to thereby analyze contaminants present in the ambient atmosphere 10, and contaminant removing means 50 which removes the contaminants in the ambient atmosphere, based on results of the analysis. Main characteristics of the environmental monitoring apparatus according to the present embodiment is that the infrared radiation source is a variable wavelength-type infrared radiation source 22 which emits infrared radiation of wavelengths controlled by an infrared radiation source driving circuit 24, and that the infrared radiation exited from the infrared transmitting substrate 12 is led to the infrared detector 34 without passing through the infrared interferometer 32.

The thus arranged environmental monitoring apparatus makes it unnecessary to use the expensive infrared interferometer 32 (FT-IR apparatus), which can make the apparatus inexpensive. Emission wavelengths of the infrared radiation source 22 can be swept, whereby even in a case that contaminants are unknown, or a plurality of contaminants whose functional groups are different from one another are present, concentrations of the contaminants can be measured without making the structure of the apparatus complicated.

As the variable wavelength infrared radiation source 22, a variable wavelength-type semiconductor light emitting element or an optical parametric oscillator using quasi phase matching, for example, can be used.

As the variable wavelength semiconductor light emitting element, variable wavelength infrared semiconductor lasers and infrared light emitting diodes are marketed. These elements can control their emission wavelengths by controlling the injection current and temperature.

The optical parametric oscillator using quasi phase matching is an element having a layer structure of a ferroelectric nonlinear optical crystal of LiNbO₃, LiTaO₃ or others laid with the dielectric polarization direction periodically reversed by 180° disposed in an oscillator, and can provide output beams of a prescribed oscillation wavelength by the irradiation of excitation beam (see, e.g., Oyo Butsuri, vol.67, No.9, pp.1046-1050 (1998)). This element can control the emission wavelength by controlling the voltage to be applied to the layer structure, and the temperature.

The infrared radiation source 22 is connected to the infrared radiation source driving circuit 24, so that the emission wavelength can be controlled by the infrared radiation source driving circuit 24. The infrared radiation source driving circuit 24 controls drive voltages and injection current to be applied to the infrared radiation source 22, or controls a variable temperature element (not shown), such as a Peltier element or others mounted on light emitting element forming the infrared radiation source 22 to control a temperature of the light emitting element, whereby a wavelength of the infrared radiation emitted by the infrared radiation source 22 is controlled.

The infrared radiation source driving circuit 24 is connected also to the computer 38. The infrared radiation source driving circuit 24 outputs wavelength setting signal for the infrared radiation to be emitted by the infrared radiation source 22 to the computer 38. Thus, the wavelength of the infrared radiation emitted by the infrared radiation source 22, and information of detected infrared radiation are related with each other for analysis.

In the environmental monitoring apparatus according to the present embodiment, a chopper 44 is disposed between the infrared transmitting substrate 12 and the infrared detector 34 and is driven by a chopper driving circuit 46, and a lock-in amplifier is disposed between the infrared detector 34 and the A/D converter 36. A chopping frequency of the chopper 44 and the detection of the infrared radiation are synchronized for improved S/N ratios. The chopper driving circuit 46 and the lock-in amplifier 48 are not essential.

In place of disposing the chopper 44 and the chopper driving circuit 46, a frequency modulation signal outputted by the infrared radiation source driving circuit 24 may be inputted to the lock-in amplifier 48 so that the frequency modulation signal can be used as a synchronization signal.

Next, the environmental monitoring method according to the present embodiment will be explained with reference to FIG. 7.

First, the infrared transmitting substrate 12 is disposed in the ambient atmosphere 10 to be measured. In FIG. 7, the infrared transmitting substrate 12 alone is disposed in the ambient atmosphere 10, but all or a part of the infrared radiation source 22, the contaminant analyzing means 30 and the contaminant removing means 50 may be disposed in the ambient atmosphere 10.

Then, a prescribed control signal is outputted from the infrared radiation source driving circuit 24 to the infrared radiation source 22 to thereby control the wavelength of the infrared radiation to be emitted by the infrared radiation source 22. Simultaneously therewith, the infrared radiation driving circuit 24 outputs to the computer 38 a wavelength setting signal for the infrared radiation to be emitted by the infrared radiation source 22.

Then, the infrared radiation emitted by the infrared radiation source 22 is irradiated to the infrared transmitting substrate 12. The infrared radiation which has entered the infrared transmitting substrate 12 undergoes multiple internal reflections on the front and the back surfaces of the infrared transmitting substrate 12, while probing contaminants adhering to the surfaces of the infrared transmitting substrate 12, collecting information of the contaminants, and exited from the infrared transmitting substrate 12 to the outside.

Next, the infrared radiation exited from the infrared transmitting substrate 12 is detected by the infrared detector 34, the absorbance spectrum of the infrared radiation is given by the computer 38 to identify/quantify the contaminants. At this time, the measured results are recorded in relationship with the wavelength signal outputted by the infrared radiation source driving circuit 24.

Then, the above-described operation is repeated while sweeping emission wavelength of the infrared radiation by the infrared radiation source driving circuit 24, whereby the relationships between the absorbance spectra and the emission wavelengths, which are equal to those given by the environmental monitoring apparatus according to the first embodiment can be measured.

Next, when concentrations of contaminants in the ambient atmosphere 10, which have been computed by the computer 38, are higher than prescribed values, the computer 38 outputs feedback control signal to the controller 52. The controller 52 which has received the feedback control signal drives the contaminant removing means to decompose/discharge the contaminants in the ambient atmosphere 10. Thus, concentrations of the contaminants in the ambient atmosphere 10 are kept lower than the prescribed values.

Then, UV radiation emitted from the UV radiation source not shown is irradiated as required to the infrared transmitting substrate 12 to thereby remove contaminants adsorbed on the surfaces of the infrared transmitting substrate 12 to initialize the substrate surfaces.

Next, the above-described measurement is repeated as required to thereby measure transient changes, etc. of contaminants in the ambient atmosphere.

As described above, according to the present embodiment, the variable wavelength-type infrared radiation source is provided, and emission wavelengths are swept, whereby contaminants of wavelengths in prescribed wavelength bands are analyzed without using the expensive FT-IR apparatus, and results of the analyses can be fed back for the control of the contaminants. The apparatus can be inexpensive.

The variable wavelength-type light emitting element which is currently available cannot sweep emission wavelengths in a wavelength range including all wavelength bands corresponding to molecular vibrations of functional groups. For the sweep of wavelengths of the infrared radiation over a wide range, the infrared radiation source 22 is arranged as exemplified below.

As described above, the variable wavelength-type light emitting element can be controlled by electric signal or temperature applied to the element itself. The light emitting element is controlled by both electric signal and temperature, whereby the emission wavelength can be controlled over a wider range than controlled by either of electric signal and temperature. The temperature of the light emitting element can be controlled by controlling electric signal applied to the variable temperature element, such as a Peltier element or others mounted on the light emitting element.

As exemplified in FIG. 8, the infrared radiation source 22 comprising a plurality of infrared radiation sources 22a-22f of emission wavelength bands different from one another arranged on a rotary disc 60 along a conical circumference is prepared. The rotary disc 60 is rotated on the rotation axis while wavelengths of the infrared radiation emitted by the infrared radiation sources 22a-22f is sequentially swept so that emission wavelengths of the infrared radiation in a wide wavelength band covered by the infrared radiation sources 22a-22f may be swept.

[A Fourth Embodiment]

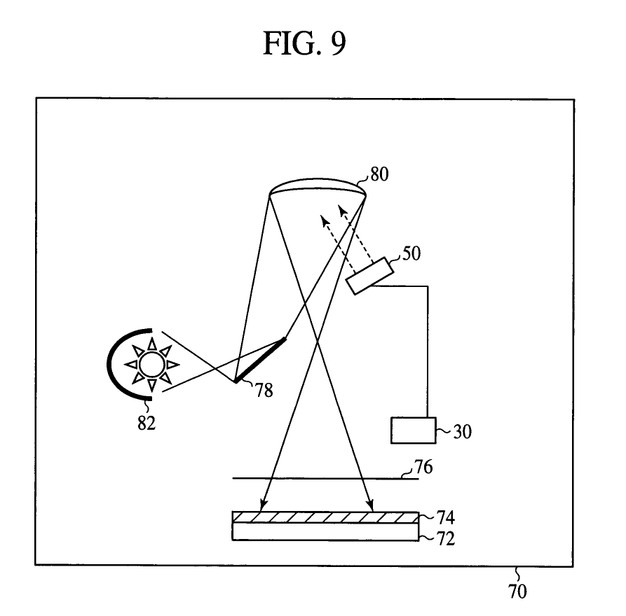

The semiconductor fabrication apparatus according to a fourth embodiment of the present invention will be explained with reference to FIG. 9. The same members of the present embodiment as those of the environmental monitoring method and apparatus according to the first to the third embodiments shown in FIGS. 1 to 8 are represented by the same reference numbers not to repeat or to simplify their explanation.

FIG. 9 is a diagrammatic view of the semiconductor fabrication apparatus according to the present embodiment.

In the present embodiment, the semiconductor fabrication apparatus with the environmental monitoring apparatus according to the first to the third embodiments mounted on will be explained by means of a photolithography apparatus.

A semiconductor wafer 72 to be processed is disposed in the photolithography apparatus closed by a casing 70. A photoresist film 74 is formed on the surface of the semiconductor wafer 72. A photo mask 76 with a prescribed pattern to be transferred drawn on is disposed above the semiconductor wafer 72. Reflection optical systems 78, 80 are disposed above the photo mask 76, so that light emitted by a light source 82 can be irradiated to the semiconductor wafer 72 via the reflection optical systems 78, 80.

In the apparatus, a contaminant analyzing means 30 which analyzes contaminants present in an ambient atmosphere in the apparatus by multiple internal reflections Fourier transform infrared spectroscopy is disposed. The contaminant analyzing means 30 can be the contaminant analyzing means 30 of the first to the third embodiments. In the present embodiment, the contaminant analyzing means 30 includes the infrared radiation source and the infrared transmitting substrate of the first to the third embodiments.

Near the reflection optical system 80, contaminant decomposing means 50 which decomposes/removes contaminants adhering to the surfaces of the reflection mirror and optical lens constituting the reflection optical system 80, and contaminants present in the ambient atmosphere in the apparatus is disposed. The contaminant decomposing means 50 can be the contaminant decomposing means of the first to the third embodiments.

As described above, in the present embodiment, the environmental monitoring method and apparatus according to the first to the third embodiments is used as the means which detect contaminants in the ambient atmosphere in the photolithography apparatus and, based on the detected concentrations, removes the contaminants adhering to the surfaces of the reflection mirror and the optical lens constituting the reflection optical system 80 and contaminants present in the ambient atmosphere.

When exposure light is irradiated to the photoresist film 74 applied to the semiconductor wafer 74, organic substances are volatilized from the photoresist film 74 into the interior of the apparatus. For example, in the case of a positive resist of DNQ-novolak resin, indene carbonate (containing C—H group as a functional group), which is an organic substance into which the photoresist has changed is released. The thus released organic substance adhering to the optical lens and the reflection mirror constituting the reflection optical system 80 impairs the reflectance and transmittance, and as more wafers are processed, a prescribed exposure cannot be obtained. As a result, a prescribed patterning cannot be performed, and defective products are fabricated. It is often that the organic substance itself in the apparatus absorbs the exposure light to resultantly decrease the exposure to the semiconductor wafers. Often organic molecules evaporated from the photoresist film 74, and additionally the accessories, the wires, the inside wall of the apparatus, etc. make the same influence.

As in the photolithography apparatus according to the present embodiment, contaminants in the ambient atmosphere in the apparatus are detected to thereby estimate amounts of light absorption by the contaminants and indirectly measure adhesion amounts of the contaminants to the surfaces of the optical lens and the reflection mirror constituting the reflection optical system 80.

The photolithography apparatus is thus arranged, whereby a timing when the contaminants in the apparatus will affect patterning characteristics is anticipated to thereby prevent the malfunction of the apparatus, and the contaminants in the apparatus can be earlier and suitably removed.

As described above, according to the present embodiment, the environmental monitoring apparatus according to the first to the third embodiments is applied to the photolithography apparatus, whereby a timing when contaminants in the apparatus will affect patterning characteristics is anticipated to thereby prevent malfunctions of the apparatus, and the contaminants in the apparatus can be earlier and suitably removed by the contaminant removing means.

In the present embodiment, all the contaminant analyzing means 30 and the contaminant removing means are disposed in the apparatus, but at least the infrared transmitting substrate 12 may be disposed in the apparatus. All or a part of the contaminant analyzing means 30 and the contaminant removing means 50 except the infrared transmitting substrate 12 may be disposed outside the apparatus.

In the present embodiment, the contaminant removing means 50 is driven based on results of the analysis by the contaminant analyzing means 30 and removed the contaminants in the apparatus, but another feedback based on results of the analysis may be performed. For example, based on analysis results, signals may be outputted for stopping the processing of the semiconductor wafers, giving operators an alarm to the effect.

[A Fifth Embodiment]

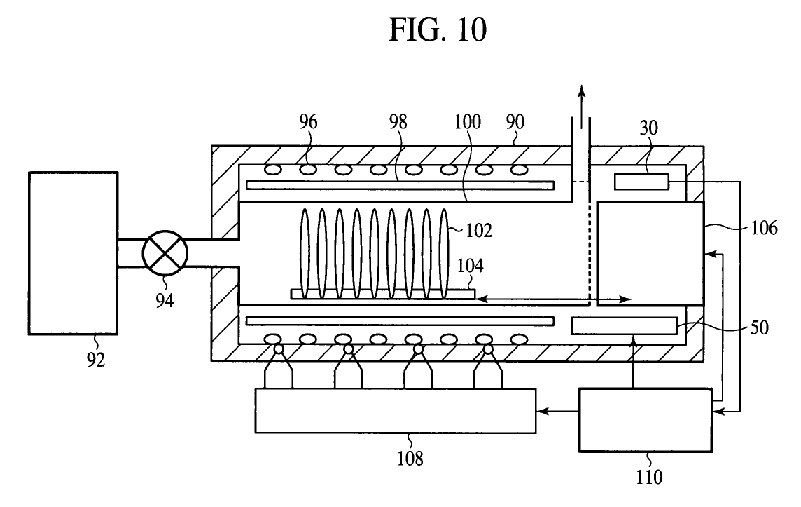

The semiconductor fabrication apparatus according to a fifth embodiment of the present invention will be explained with reference to FIG. 10.

The same members of the present embodiment as those of the environmental monitoring method and apparatus according to the first to the third embodiments shown in FIGS. 1 to 8 are represented by the same reference numbers not to repeat or to simplify their explanation.

FIG. 10 is a view diagrammatically showing the semiconductor fabrication apparatus according to the present embodiment.

In the present embodiment, the semiconductor fabrication apparatus with the environmental monitoring apparatus according to the first to the third embodiments mounted on will be explained by means of an oxide film forming apparatus. Oxide film forming apparatus are used in device fabrication steps for various purposes of forming selective oxidized films, device isolation films, gate oxide films, inter-layer insulation films, etc.

In a casing 90, a furnace tube 100 which is a reaction chamber for growing silicon oxide film is disposed. The furnace tube 100 is connected to a gas supply system 92 via valve 94, so that gases (oxygen gas, inert gas as a dilution gas, etc.) necessary to form silicon oxide film can be fed into the furnace tube 100. A heater 96 for heating the furnace tube 100 is wound on the furnace tube 100 with a soaking tube 98 for equalizing the heat distribution in the furnace interposed therebetween. In a region of the interior of the casing 90, which is adjacent to the furnace tube 100, there is disposed automatic wafer loading/unloading means 106 which loads semiconductor wafers 102 to be process into the furnace tube 100 and unloading the processed semiconductor wafers 102.

Contaminant analyzing means 30 for detecting contaminants in the ambient atmosphere in the furnace and contaminant removing means 50 for removing contaminants in the furnace, based on a result of the analysis by the contaminant analyzing means 30 are disposed inside the furnace wall 90. The contaminant analyzing means 30 and the contaminant removing means 50 can be the contaminant analyzing means and the contaminant removing means of the first to the third embodiments. In the present embodiment, the contaminant analyzing means 30 includes the infrared radiation source and the infrared transmitting substrate of the first to the third embodiments.

A temperature controller 108 which detects a temperature inside the furnace to control the heater 96 to be a prescribed temperature is provided on the casing 90. The automatic wafer loading/unloading means 106 and the temperature controller 108 are connected to a computer 110 which is a part of or independent of the contaminant analyzing means 30, so as to be controlled by them.

Thus, in the semiconductor fabrication apparatus according to the present embodiment, the environmental monitoring method and apparatus according to the first to the third embodiments is utilized as means for detecting contaminants in the ambient atmosphere in the furnace of the oxide film forming apparatus and, based on concentrations of the contaminants, removing the contaminants in the ambient atmosphere in the furnace.

When semiconductor wafers 102 to be processed are loaded into the furnace tube 100, the plural semiconductor wafers 102 are arranged on a wafer boat 104 to be inserted into a prescribed temperature region of the furnace tube 100 by the automatic wafer loading/unloading means 106. The semiconductor wafers 102 which have been processed are unloaded by the automatic wafer loading/unloading means 106, arranged similarly in the wafer boat 104. The automatic wafer loading/unloading means 106 includes a boat loading mechanism for loading/unloading semiconductor wafers 102, a semiconductor wafer transfer mechanism for transferring the semiconductor wafers, a carrier stocker for conveying and stowing carriers, etc. In addition to the automatic wafer loading/unloading means 106, mechanical parts, electric parts, etc. are present. Thus, organic molecules (DOP (dioctyl phthalate as plasticizers), siloxane as flame retardants, etc.) volatilized from the accessories, the wires, the inside walls of the apparatus, etc. adhere to the surfaces of the semiconductor wafers 102, and when the organic molecules adhere to the processed wafers, product defects, such as carbon atoms (good conductor) in the organic molecules become nuclei for causing progressive dielectric breakdown, are often caused.

As in the oxide film forming apparatus according to the present embodiment, the contaminant analyzing means 30 is provided to detect contaminants in the furnace, whereby it can be immediately judged whether concentrations of the contaminants in the furnace will affect product yields. An analysis result can be immediately fed back to the contaminant removing means 50. The oxide film forming apparatus is thus arranged, whereby product defects due to contaminants in the furnace can be precluded, and the contaminant removing means 50 can earlier and suitably remove the contaminants in the furnace.

As described above, according to the present embodiment, the environmental monitoring apparatus according to the first to the third embodiments is applied to the oxide film forming apparatus, whereby a timing when contaminants in the apparatus will affect product yields is anticipated to thereby prevent malfunctions of the apparatus, and the contaminants in the apparatus can be earlier and suitably removed by the contaminant removing means.

In the present embodiment, all the contaminant analyzing means 30 and the contaminant removing means 50 are disposed in the apparatus, but at least the infrared transmitting substrate 12 may be disposed in the apparatus. All or a part of the contaminant analyzing means and the contaminant removing means 50 except the infrared transmitting substrate 12 may be disposed outside the apparatus.

In the present embodiment, the contaminant removing means 50 is driven based on results of the analysis by the contaminant analyzing means 30 and removed the contaminants in the apparatus, but another feedback based on results of the analysis may be performed. For example, based on analysis results, signals may be outputted for stopping the processing of the semiconductor wafers, giving operators an alarm to the effect.

In the present embodiment, the semiconductor fabrication apparatus according to the present invention is explained by means of the oxide film forming apparatus but is applicable to other semiconductor fabrication apparatuses using furnace tubes, e.g., semiconductor fabrication apparatuses having furnaces for thermal diffusion and various anneals.

[Modifications]

The present invention is not limited to the above-described embodiments and can cover other various modifications.

In the above-described fourth embodiment, the environmental monitoring apparatus according to the first to the third embodiments is applied to the photolithography apparatus, and in the above-described fifth embodiment, the environmental monitoring apparatus according to the first to the third embodiments is applied to the oxide film forming apparatus. However, the environmental monitoring apparatus according to the first to the third embodiments are similarly applicable to, e.g., electron beam aligners, dry cleaning apparatus, film forming apparatus, etching apparatus, etc.

A number of electric apparatuses, wires and accessories are present in a semiconductor fabrication apparatus, and organic molecules of plasticizers of vinyl chloride and plastics and of flame retardants, etc. released little by little continuously from the walls of the apparatuses are released into the apparatus. When such contaminants adhere to insulation films of semiconductors, for example, a problem that the carbon atoms become good conductor, causing the dielectric breakdown is often caused. By mounting the environmental monitoring apparatus according to the present invention on semiconductor fabrication apparatus, monitor of such contaminants and the feedback of monitor results can be instantaneously and suitably performed.

In the above-described embodiments, the environmental monitoring apparatus according to the present invention is applied to the control of contaminants in semiconductor fabrication apparatuses, but the environmental monitoring method and apparatus according to the present invention are applicable to monitor of contaminants and feedback of results of the monitor in other various closed spaces.

For example, the environmental monitoring method and apparatus according to the present invention are applicable to the monitor of contaminants in clean room and the feedback of monitor results. When the above-described gases containing organic molecules generated in semiconductor fabrication apparatuses are released, there is a risk that the gases may contaminate semiconductor wafers in other steps and semiconductor wafers being transferred from a apparatus to a apparatus. Contaminants in the clean room are monitored and fed back to thereby reduce concentrations of the contaminants in the clean room and improve production yields.

The environmental monitoring method and apparatus according to the present invention is applicable to the monitor of contaminants in spaces where humans lives. Recently, it has been seen that environmental contaminants, such as dioxin generated from incinerators and formaldehyde generated from furniture, walling materials, etc., affect health of the human, and animals and plants. It is strongly required to control the discharge of such substances. Thus, contaminants released into spaces where the human lives are monitored and fed back, whereby concentrations of the environmental contaminants are decreased so as to prevent the impairment of heath of the human.

The environmental monitoring method and apparatus according to the present invention are applicable to not only closed spaces but also the monitor of exhaust gases from various apparatus, cars, chemical plants, etc., and the feedback of monitor results. Such exhaust gages often contain original substances (SOx, NOx. dioxin, etc.) which cause the earth warming and impairment of human health. Before such exhaust gases are discharged, the contaminants contained in such exhaust gases are monitored, and the exhaust gases are purified based on results of the monitor, and then such exhaust gases are discharged, whereby concentration of the toxic contaminants contained in the exhaust gases can be decreased, which can prevent the pollution of the outside environments.

### INDUSTRIAL APPLICABILITY

In the environmental monitoring method and apparatus according to the present invention, infrared radiation is irradiated to an infrared transmitting substrate disposed in a prescribed ambient atmosphere, undergoes multiple internal reflections in the infrared transmitting substrate and exited from the infrared transmitting substrate to be detected, and concentrations of contaminants in the ambient atmosphere are measured based on the detected infrared radiation, whereby the ambient atmosphere is controlled. Thus, the environmental monitoring method and apparatus are useful to be used for detecting the contaminants in the ambient atmosphere simply and immediately at low cost and feeding back the results of the measurement for the environmental control. The environmental monitoring method and apparatus are useful to be used in the semiconductor fabrication apparatus.

1. An environmental monitoring method comprising the steps of:
irradiating an infrared radiation to an infrared transmitting substrate disposed in a prescribed ambient atmosphere;
detecting the infrared radiation exited from the infrared transmitting substrate after the infrared radiation has undergone multiple reflections inside the infrared transmitting substrate;
measuring a concentration of a contaminant in the ambient atmosphere, based on the detected infrared radiation; and
controlling the ambient atmosphere, based on the measured concentration of the contaminant in the ambient atmosphere.

2. An environmental monitoring method according to claim 1, wherein
the detected infrared radiation is spectroscopically analyzed to measure a kind and/or a concentration of the contaminant in the ambient atmosphere.

3. An environmental monitoring method according to claim 1, wherein
the infrared radiation having a wavelength band corresponding to a molecular vibration wavelength of a specific contaminant is selectively detected to measure a concentration of the specific contaminant in the ambient atmosphere.

4. An environmental monitoring method according to claim 1, wherein
the infrared radiation is irradiated to the infrared transmitting substrate while the wavelength of the infrared radiation are being swept, and the concentration of the contaminant in the ambient atmosphere whose molecular vibration wavelength is present in a swept wavelength band are measured.

5. An environmental monitoring method according to claim 1, wherein
when the measured concentration of the contaminant in the ambient atmosphere is higher than a prescribed value, the contaminant in the ambient atmosphere is removed.

6. An environmental monitoring method according to claim 2, wherein
when the measured concentration of the contaminant in the ambient atmosphere is higher than a prescribed value, the contaminant in the ambient atmosphere is removed.

7. An environmental monitoring method according to claim 3, wherein
when the measured concentration of the contaminant in the ambient atmosphere is higher than a prescribed value, the contaminant in the ambient atmosphere is removed.

8. An environmental monitoring method according to claim 4, wherein
when the measured concentration of the contaminant in the ambient atmosphere is higher than a prescribed value, the contaminant in the ambient atmosphere is removed.

9. An environmental monitoring apparatus comprising:
an infrared transmitting substrate disposed in a prescribed ambient atmosphere;
an infrared radiation source for irradiating infrared radiation to the infrared transmitting substrate;
a contaminant analyzing means for computing a concentration of a contaminant in the ambient atmosphere, based on the infrared radiation exited from the infrared transmitting substrate after the infrared radiation has undergone multiple reflections inside the infrared transmitting substrate; and
a contaminant removing means for removing the contaminant in the ambient atmosphere complied with the concentration of the contaminant in the ambient atmosphere computed by the contaminant analyzing means.

10. An environmental monitoring apparatus according to claim 9, wherein
the contaminant analyzing means measures a kind and/or the concentration of the contaminant in the ambient atmosphere by spectroscopically analyzing the detected infrared radiation.

11. An environmental monitoring apparatus according to claim 9, which further comprises:
an infrared-band transmitting filter for selectively transmitting the infrared radiation of a wavelength band corresponding to a molecular vibration wavelength of a specific contaminant; and in which
the contaminant analyzing means measures the concentration of the specific contaminant in the ambient atmosphere by analyzing the infrared radiation which has passed through the infrared-band transmitting filter.

12. An environmental monitoring apparatus according to claim 9, wherein
the infrared radiation source is a variable emission wavelength-type infrared radiation source which sweeps emission wavelength of the infrared radiation to irradiate the infrared radiation to the infrared transmitting substrate; and
the contaminant analyzing means measures the concentration of the contaminant in the ambient atmosphere whose molecular vibration wavelength is present in a wavelength band of the swept infrared radiation, based on the detect infrared radiation.

13. A semiconductor fabrication apparatus comprising:
semiconductor wafer processing means for performing a prescribed processing on a semiconductor wafer disposed in a prescribed ambient atmosphere;
an infrared transmitting substrate disposed in the ambient atmosphere;
an infrared radiation source for irradiating an infrared radiation to the infrared transmitting substrate;
a contaminant analyzing means for computing a concentration of a contaminant in the ambient atmosphere, based on the infrared radiation exited from the infrared transmitting substrate after the infrared radiation has undergone multiple reflections inside the infrared transmitting substrate; and
a contaminant removing means for removing the contaminant in the ambient atmosphere, based on the concentration of the contaminant in the ambient atmosphere computed by the contaminant analyzing means.

14. A semiconductor fabrication apparatus according to claim 13, wherein
the contaminant is a substance which becomes a barrier to proceeding the prescribed processing by the semiconductor wafer processing means.

15. A semiconductor fabrication apparatus according to claim 13, wherein
the semiconductor wafer processing means is an aligner for exposing the semiconductor wafer via optical parts which reflect or transmit light; and
the contaminant removing means removes the contaminant adhering to the surfaces of the optical parts.

16. A semiconductor fabrication apparatus according to claim 14, wherein
the semiconductor wafer processing means is an aligner for exposing the semiconductor wafer via optical parts which reflect or transmit light; and
the contaminant removing means removes the contaminant adhering to the surfaces of the optical parts.
